(19) United States
(12) Patent Application Publication
(10) Pub. No.: US 2023/0408718 A1
(43) Pub. Date: Dec. 21, 2023

(54) METHOD AND SYSTEM FOR GENERALIZABLE DEEP LEARNING FRAMEWORK FOR SEISMIC VELOCITY ESTIMATION ROBUST TO SURVEY CONFIGURATION

(71) Applicant: ARAMCO SERVICES COMPANY, Houston, TX (US)

(72) Inventors: Yong Ma, Katy, TX (US); Weichang Li, Katy, TX (US)

(73) Assignee: ARAMCO SERVICES COMPANY, Houston, TX (US)

(21) Appl. No.: 17/807,100

(22) Filed: Jun. 15, 2022

(51) Int. Cl. G01V 1/30; G01V 1/104; G01V 1/28

(52) U.S. Cl. CPC G01V 1/301; G01V 1/303; G01V 1/104; G01V 1/282; G01V 2210/6222

(57) ABSTRACT

A method which includes obtaining an initial velocity model and perturbing the initial velocity model to form a first plurality of velocity models. The method includes using a forward model to simulate seismic data sets from the first plurality of velocity models and transforming the seismic data sets to the wavenumber-time domain. The method includes training a machine-learned model using the first plurality of velocity models and the transformed seismic data sets, wherein the machine-learned model is configured to accept transformed seismic data. The method includes obtaining a second seismic data set for a subsurface region of interest, wherein the second seismic data set is acquired according to a second survey configuration and transforming the second seismic data set to the wavenumber-time domain. The method further includes processing the second transformed data set with the trained machine-learned model to predict a second velocity model for the subsurface region of interest.

### BACKGROUND

In the context of oil and gas exploration and production, a variety of tools and methods are employed to model subsurface regions. An accurate seismic velocity model is critical for geophysical exploration and oil and gas field planning. Generally, layers of rock in the subsurface of the Earth are formed through deposits of sediment over time and under a variety of environmental conditions. As such, layers of rock may be composed of different constituents and may have different physical and/or chemical properties. A velocity model maps the speed at which seismic waves travel through the subsurface. Consequently, a velocity model may be used, among other things, to identify the structure of the subsurface (e.g. the depth of subsurface formations).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

One or more embodiments disclosed herein generally relate to a method. The method includes obtaining an initial velocity model and perturbing the initial velocity model to form a first plurality of velocity models. The method further includes using a forward model to simulate a first plurality of seismic data sets from the first plurality of velocity models and transforming the first plurality of seismic data sets to the wavenumber-time domain to form a first plurality of transformed seismic data sets. The method further includes training a machine-learned model using the first plurality of velocity models and the first plurality of transformed seismic data sets, wherein the machine-learned model is configured to accept transformed seismic data. The method further includes obtaining a second seismic data set for a subsurface region of interest, wherein the second seismic data set is acquired according to a second survey configuration and transforming the second seismic data set to the wavenumber-time domain to form a second transformed seismic data set and processing the second transformed data set with the trained machine-learned model to predict a second velocity model for the subsurface region of interest.

One or more embodiments disclosed herein generally relate to a non-transitory computer readable medium storing instructions executable by a compute processor. The instructions include functionality for obtaining an initial velocity model, perturbing the initial velocity model to form a first plurality of velocity models, and using a forward model to simulate a first plurality of seismic data sets from the first plurality of velocity models. The instruction further include functionality for transforming the first plurality of seismic data sets to the wavenumber-time domain to form a first plurality of transformed seismic data sets. The instructions further include functionality for training a machine-learned model using the first plurality of velocity models and the first plurality of transformed seismic data sets, wherein the machine-learned model is configured to accept transformed seismic data. The instructions further include functionality for obtaining a second seismic data set for a subsurface region of interest, wherein the second seismic data set is acquired according to a second survey configuration and transforming the second seismic data set to the wavenumber-time domain to form a second transformed seismic data set. The instructions further include functionality for processing the second transformed data set with the trained machine-learned model to predict a second velocity model for the subsurface region of interest.

One or more embodiments disclosed herein generally relate to a system which includes an initial velocity model, a forward modelling procedure, a machine-learned model, a second seismic data set for a subsurface region of interest, wherein the second seismic data set is acquired according to a second survey configuration, and a computer. The computer includes one or more computer processors, and a non-transitory computer readable medium storing instructions executable by a computer processor. The instructions include functionality for perturbing the initial velocity model to form a first plurality of velocity models and using the forward modelling procedure to simulate a first plurality of seismic data sets from the first plurality of velocity models. The instructions further include functionality for transforming the first plurality of seismic data sets to the wavenumber-time domain to form a first plurality of transformed seismic data sets and training the machine-learned model using the first plurality of velocity models and the first plurality of transformed seismic data sets, wherein the machine-learned model is configured to accept transformed seismic data. The instructions further include functionality for transforming the second seismic data set to the wavenumber-time domain to form a second transformed seismic data set and processing the second transformed data set with the trained machine-learned model to predict a second velocity model for the subsurface region of interest.

Other aspects and advantages of the claimed subject matter will be apparent from the following description and the appended claims.

### BRIEF DESCRIPTION OF DRAWINGS

FIGS. 1A and 1B depict seismic surveys in accordance with one or more embodiments.

FIG. 2 depicts select configuration parameters of a seismic survey in accordance with one or more embodiments.

FIG. 3 illustrates a flowchart in accordance with one or more embodiments.

FIG. 4 depicts a system in accordance with one or more embodiments.

FIG. 5A depicts a recurrent neural network in accordance with one or more embodiments.

FIG. 5B demonstrates pseudo-code for an algorithm in accordance with one or more embodiments.

FIG. 5C depicts an unrolled recurrent neural network in accordance with one or more embodiments.

FIG. 5D depicts a long short-term memory network in accordance with one or more embodiments.

FIG. 6 depicts a neural network in accordance with one or more embodiments.

FIG. 7 depicts a flowchart in accordance with one or more embodiments.

FIG. 8 depicts a plurality of velocity models in accordance with one or more embodiments.

FIG. 9A depicts seismic source wavelets in accordance with one or more embodiments.

FIG. 9B depicts seismic source wavelets in the frequency domain in accordance with one or more embodiments.

FIG. 10A depicts seismic data in accordance with one or more embodiments.

FIG. 10B depicts seismic data transformed to the wavenumber-time domain in accordance with one or more embodiments.

FIG. 11 depicts an instance of a machine-learned model in accordance with one or more embodiments.

FIG. 12A demonstrates machine-learned model predictions in accordance with one or more embodiments.

FIG. 12B demonstrates machine-learned model predictions in accordance with one or more embodiments.

FIG. 13 illustrates an error comparison between model implementations in accordance with one or more embodiments.

FIG. 14 depicts a system in accordance with one or more embodiments.

### DETAILED DESCRIPTION

Generally, layers of rock in the subsurface of the Earth are formed through deposits of sediment over time and under a variety of environmental conditions. As such, layers of rock may be composed of different constituents and may have different physical and/or chemical properties. Subsurface rock properties may be anisotropic. In order to describe and model a subsurface region of the Earth, a variety of data collection methods may be employed. These methods may include, but are not limited to: collecting data from one or more wells disposed throughout the subsurface, which may include subsurface logs and/or petrophysical logs; conducting a seismic survey; collecting data from previously drilled, nearby wells, sometimes called “offset” wells; and collecting so-called “soft” data, such as outcrop information and data describing analogous modern geological or depositional environments. The collected data may be used to construct, or otherwise inform, a subsurface model. Once constructed, subsurface models may include information about the spatial distribution of subsurface formation properties such as, but not limited to: porosity; mineral content; chemical makeup; and density. Additionally, the modeled subsurface region may include information about the subsurface formation geological unit thicknesses.

An accurate subsurface model is critical for geophysical exploration, such as the identification of reservoirs, and for oil and gas field planning and lifecycle management. One such subsurface model is a seismic velocity model (“velocity model”). A velocity model maps the speed at which seismic waves travel through the subsurface. Consequently, a velocity model may be used, among other things, to identify the structure of the subsurface (e.g. the depth of subsurface formations), to aid in imaging seismic pre-stack data, and to monitor carbon dioxide (CO₂) distributions and retention. Further, a velocity model may be integrated with, or inform, other subsurface models. Typically, the velocity at which seismic waves travel through the subsurface cannot be directly measured. As such, a velocity model is generally constructed by processing recorded seismic data. Seismic data may be obtained through a seismic survey, which will be described in greater detail below. Processing seismic data to obtain a velocity model may be considered an inverse problem, where the applied process must determine the subsurface velocity model that resulted in the recorded seismic data.

The various processes and techniques used to process seismic data to form a velocity model may generally be categorized as either a “data-domain approach”, such as full-waveform inversion (FWI), or an “image-domain approach”, such as migration velocity analysis. Among these processes and techniques to construct a subsurface velocity model from seismic data, FWI is considered the state-of-the-art industry practice. However, FWI suffers because many different velocity models can be formed for a seismic data set. That is, FWI solutions are non-unique. Consequently, an FWI solution is sensitive to aspects of the recorded data, such as the lack of low frequencies, the initial starting model, or the acquisition method and configuration of the seismic survey.

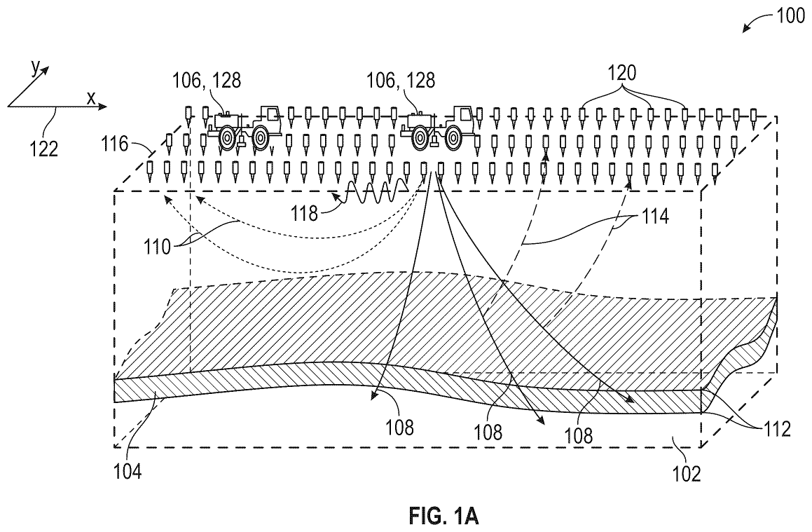

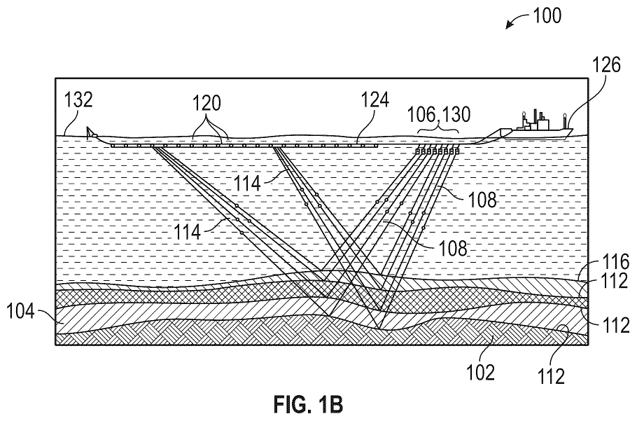

Turning to FIGS. 1A and 1B, these figures depict how seismic data may be acquired through a seismic survey (100). In particular, FIGS. 1A-1B show a seismic survey (100) of a subterranean region of interest (102), which may contain a hydrocarbon reservoir (104). In some cases, the subterranean region of interest (102) may lie beneath an area of dry land, as shown in FIG. 1A. In other cases, the subterranean region of interest (102) may lie beneath a lake, sea, or ocean, as shown in FIG. 1B. The seismic survey (100) may utilize a seismic source (106) that generates radiated seismic waves (108). The type of seismic source (106) may depend on the environment in which it is used, for example on land the seismic source (106) may be a vibroseis truck (128) or an explosive charge, but in water the seismic source (106) may be an airgun (or a series of airguns (130)). FIG. 1B depicts a series of airguns (130) being towed, or pulled, by a vessel (126) while conducting the seismic survey (100).

In FIG. 1A, the radiated seismic waves (108) may return to the surface of the earth (116) as refracted seismic waves (110) or may be reflected by geological discontinuities (112) and return to the surface as reflected seismic waves (114). The radiated seismic waves may propagate along the surface as Rayleigh waves or Love waves, collectively known as “ground-roll” (118). Vibrations associated with ground-roll (118) do not penetrate far beneath the surface of the earth (116) and hence are not influenced, nor contain information about, portions of the subterranean region of interest (102) where hydrocarbon reservoirs (104) are typically located. Seismic receivers (120) located on or near the surface of the earth (116) detect reflected seismic waves (114), refracted seismic waves (110) and ground-roll (118).

Likewise, as shown in FIG. 1B, the radiated seismic waves (108) may return to the surface of the body of water (e.g., lake, ocean, etc.) (132), after being reflected by geological discontinuities (112), as reflected seismic waves (114). Seismic receivers (120) located on or near the surface of the body of water (132) detect the reflected seismic waves (114). As shown in FIG. 1B, the seismic receivers (120) may be connected as a buoyant assembly known as a streamer (124) which is also towed by the vessel (126). In other implementations, the reflected seismic waves (114) may be detected and recorded through one or more ocean bottom nodes (OBNs) (not shown). An OBN, in its simplest form, is a seismic receiver (120), equipped with a battery, clock, and geophone, disposed on the floor of a body of water (e.g., the ocean floor). Generally, using a system of OBNs improves data coverage and fidelity.

Returning to FIG. 1A, in accordance with one or more embodiments the refracted seismic waves (110), reflected seismic waves (114), and ground-roll (118) generated by a single activation of the seismic source (106) are recorded by a seismic receiver (120) as a time-series representing the amplitude of ground-motion at a sequence of discreet sample times. Usually the origin of the time-series, denoted t=0, is determined by the activation time of the seismic source (106). This time-series may be denoted as a seismic “trace”. The seismic receivers (120) are positioned at a plurality of seismic receiver locations which we may denote as (xᵣ, yᵣ) where x and y represent orthogonal axes (122) on the surface of the earth (116) above the subterranean region of interest (102). Thus, the plurality of seismic traces generated by activations of the seismic source (106) at a single location may be represented as a three-dimensional “3D” volume with axes (xᵣ, yᵣ, t) where (xᵣ, yᵣ) represents the location of the seismic receiver (120) and t denotes the time sample at which the amplitude of ground-motion was measured. The collection of seismic traces is herein referred to as the seismic data set.

However, a seismic survey (100) may include recordings of seismic waves generated by a seismic source (106) sequentially activated at a plurality of seismic source locations denoted (xₛ,yₛ). In some cases, a single seismic source (106) may be activated sequentially at each source location. In other cases, a plurality of seismic sources (106) each positioned at a different location may be activated sequentially. In accordance with one or more embodiments a plurality of seismic sources (106) may be activated during the same time period, or during overlapping time periods.

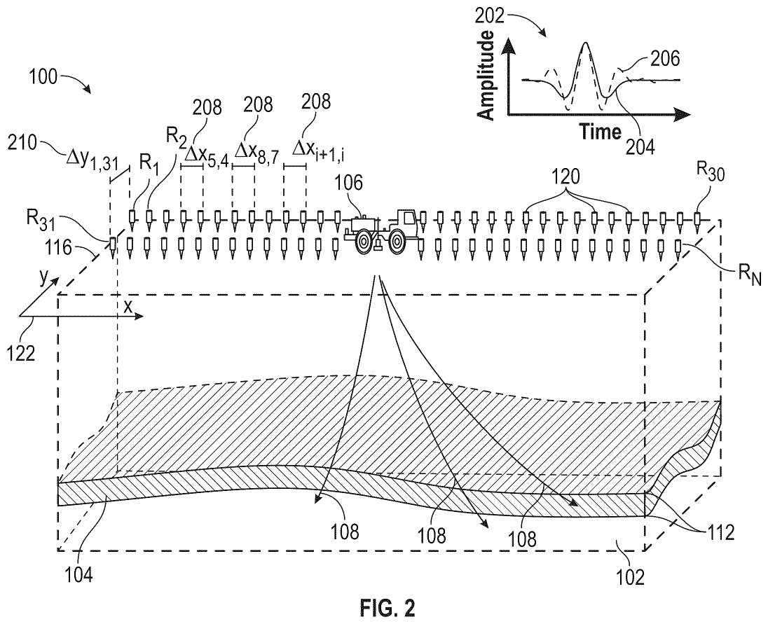

A seismic survey (100) may further be specified by its configuration. For example, the configuration of a seismic survey (100) may dictate the spacing between adjacent seismic receivers (120), the number of seismic receivers (120), the locations (xᵣ, yᵣ) of the seismic receivers (120), and the signature (i.e., the characteristics) of the initial radiated seismic wave (108) emitted from the seismic source (106). FIG. 2 continues to demonstrate the seismic survey (100) of FIG. 1A, however, some elements have been removed and others added to better depict the configuration of the seismic survey (100). In FIG. 2, each seismic receiver (120) is assigned a unique identifier, Rᵢ, where i is a number between 1 and the total number of seismic receivers (120). For generality, the total number of seismic receivers is given by N. Under this notation, the spacing between any pair of seismic receivers (120), with respect to the orthogonal axes (122), may be determined as

Δx_{j,i}=x_{R}_{ⱼ}−X_{R}_{ᵢ},

Δy_{j,i}=y_{R}_{ⱼ}−y_{R}_{ᵢ}. EQ1

FIG. 2 depicts the spacing between a few select pairs of adjacent seismic receivers (120) with respect to the x axis (208), and with respect to the y axis (210). When the spacing between seismic receivers (120) is the same for all adjacent pairs of seismic receivers (120) (e.g., Δx_{j,i}=Δx, ∀ adjacent pairs (i,j)) the seismic survey (100) is said to be configured with regular spacing. Note that under regular spacing Δx need not equal Δy. In the case of regular spacing, when describing the configuration of the seismic survey (100), the spacing may be specified solely with the values Δx and Δy. For irregular spacing, the spacing between all adjacent pairs of seismic receivers (120) or the location of each seismic receiver (120) may be specified. As previously stated, the configuration of a seismic survey (100) may dictate the signature of the initial radiated seismic wave (“wavelet”) emitted from the seismic source (106). FIG. 2 depicts various potential wavelet signatures (202). For example, the wavelet may be a Ricker wave (204) or a flat spectrum wave (206). The relative shapes of the wavelets (202) shown in FIG. 2 are provided only as examples. One with ordinary skill in the art will appreciate that a wavelet (202) must be further specified with information about its amplitude and phase or frequency spectra. As such, the examples of FIG. 2 do not impose a limitation on the present disclosure. Similar seismic survey (100) configurations may be designed and specified for other implementations, such as the use of a streamer (124) or one or more OBNs as a seismic receiver (120).

In one aspect, embodiments disclosed herein generally relate to a deep learning (DL)-based framework to construct a velocity model from seismic data. The DL-based framework is highly generalizable and robust to various configurations under which seismic data may be acquired. For the present discussion, deep learning (DL) may be considered a subset of machine learning (ML). Machine learning (ML), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein and deep learning (DL) will refer to a subset of machine learning (ML) which deals with so-called “deep” models. For example, a deep model may be a neural network with one or more hidden layers. However, one skilled in the art will recognize that the concepts and methods detailed hereafter are not limited by this choice of nomenclature.

Machine-learned model types may include, but are not limited to, generalized linear models, Bayesian regression, random forests, and deep models such as neural networks, convolutional neural networks, and recurrent neural networks. Machine-learned model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture”. As such, a DL-based framework consists of methods and systems to transform data, or otherwise determine a quantity, which leverage at least one machine-learned model which may be considered deep. A DL-based framework may include methods and processes to select a machine-learned model type and associated architecture, evaluating said machine-learned model, and using the machine-learned model in a production setting (also known as deployment of the machine-learned model).

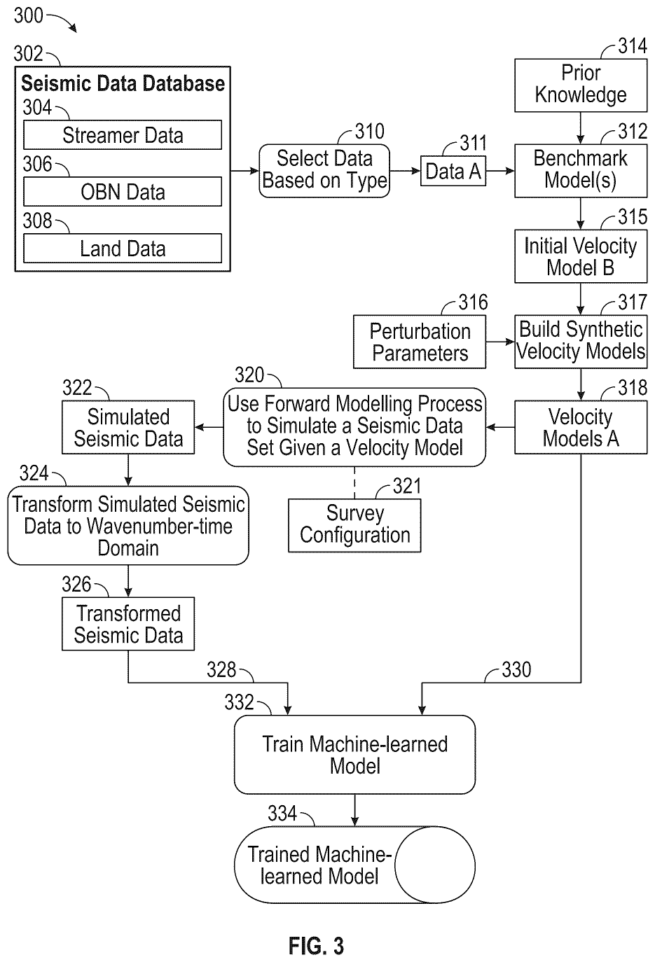

In accordance with one or more embodiments, FIG. 3 depicts a DL-based framework (300) to determine a velocity model from seismic data. The goal of the DL-based framework (300) is to train a machine-learned model—specifically, a deep model—to determine a velocity model given seismic data. As will be shown, the DL-based framework (300) produces a trained machine-learned model which is robust to changes in the configuration under which the seismic survey (100) used to acquire the seismic data is performed. This, in turn, increases the generalization power of the trained machine-learned model, or the ability of the model to accurately determine a velocity model even using seismic data which differs from that seen during model training. As depicted in FIG. 3, and in accordance with one or more embodiments, DL-based framework (300) includes a seismic data database (302). The seismic data database (302) contains various types of seismic data, such as marine streamer data (304), OBN data (306), and land data (308). It is noted that for each data type, the representative geology characteristics can be significantly different from the others. As such, a machine-learned model is trained according to each type of data. That is, while the final trained machine-learned model is robust to changes in configuration (e.g., seismic receiver (120) spacing, source signature, etc.), it is not expected to generalize across different seismic survey acquisition methods such as using a streamer (124) (array of geophones) or OBNs (i.e., different seismic receiver (120) types).

Based on the machine-learned model being developed, seismic data are selected from the seismic data database (302) according to a data type (such as streamer data (304)), as shown in block 310. The selected seismic data are referenced as Data A (311). Continuing with the DL-based framework (300) depicted in FIG. 3, the Data A (311) are used to build one or more synthetic velocity models. To do so, an initial velocity model is generated from the Data A (311) using one or more benchmark models (312) with incorporation of some prior knowledge (314). A benchmark model (312) is any model, previously employed or created, that determines a velocity model from seismic data. A benchmark model (312) may include a machine-learned model, created conventionally, without the benefit of the DL-based framework (300) approach in its entirety. As will be shown below, a benchmark model (312) is not robust to seismic survey acquisition methods. Prior knowledge (314) may include information about the subsurface region of interest, such as the knowledge about geology, geophysics, and petrophysics. In FIG. 3, the initial velocity model is referenced as the initial velocity model B (315). A velocity model can be represented as

m=m(x), EQ 2

where x represents a spatial coordinate, such as a location in a subterranean region of interest (102) defined by an x-axis coordinate, a y-axis coordinate, and a depth, d, (e.g. (x, y, d)), and m is a vector indicating the directional velocities at the spatial coordinate x. In some implementations, the subterranean region of interest (102) may be isotropic such that the velocity m at a spatial coordinate may be represented as a scalar.

To build the synthetic velocity models, as depicted in block 317, the initial velocity model B (315) is perturbed according to perturbation parameters (316). The perturbation parameters may indicate the number of synthetic velocity models to produce and a set of parameters governing the likelihood and magnitude of variation to be applied to the initial velocity model B (315). The resulting perturbed synthetic velocity models are known as velocity models A (318). To be concrete, if K synthetic velocity models are generated by perturbing the initial velocity model B (315), then velocity models A (318) is composed of K velocity models, which may be represented as m₁, m₂, . . . , m_{K-1}, m_{K}.

Continuing with FIG. 3, and in accordance with one or more embodiments, the velocity models A (318) can be used with a forward modeling process to simulate the seismic data that would be acquired according to a prescribed survey configuration (321). The forward modeling process simulates the propagation of a seismic wave from one or more seismic sources (106) through a subterranean region of interest (102) to one or more seismic receivers (120). To model the wave propagation, the forward modeling process requires a governing equation such as, for example, the generalized wave equation. The forward modelling process may employ a finite difference method to solve the following expression of the wave equation:

$$( m \frac{{\partial }^{2}}{\partial {t}^{2}} - {∇}^{2} ) p ( x , t ; {x}_{s} ) = f ( t ) δ ( x - {x}_{s} ) . \qquad EQ 3$$

In EQ. 3, m is the velocity vector at a spatial coordinate x as given by a supplied velocity model, ∇² is the Laplacian operator, p represents the seismic wave wavefield, xₛ is the spatial coordinate for a seismic source (106), and ƒ(t) is the signature of the seismic source (106) (e.g., a Ricker wavelet (204)). Thus, seismic data can be simulated at an arbitrary seismic receiver (120) location xₛ. The recorded simulated seismic data may be obtained through the expression:

d(xᵣ,t;xₛ)=p(x,t;xₛ)δ(x−xᵣ). EQ 4

The entire forward modelling process may be represented as F, such that

D=F(m;survey configuration). EQ 5

The forward modelling process, F, accepts a velocity model of the subterranean region of interest (102) (e.g., one of the velocity models from velocity models A (318)), and a survey configuration (321). The survey configuration (321) includes, at a minimum, information about the seismic source (106) location, the emitted source signature, and the location of the seismic receivers (120). D represents the recorded data, or the simulated recorded data at each seismic receiver (120). In other words, D is a collection of traces, herein referred to as a seismic data set. Because a seismic data set D is a collection of traces, where each trace is a record in time of the amplitude of ground motion at a location of a seismic receiver (120), the seismic data set D can be said to be in the space-time domain (“X-t domain”). The forward modelling process is depicted in block 320 of FIG. 3. It is emphasized that the forward modelling process is applied to each velocity model (m₁, m₂, . . . , m_{K-1}, m_{K}) in velocity models A (318) such that there are K simulated seismic data sets, D₁, D₂, . . . , D_{K-1}, D_{K}. The collection of K simulated seismic data sets is referenced as simulated seismic data (322).

As depicted in block 324, each seismic data set in the simulated seismic data (322) is transformed from the space-time domain (“X-t domain”) to the wavenumber-time domain (“K-t domain”). In accordance with one or more embodiments, the transformation is applied by first sorting a seismic data set D to the common middle point (CMP) domain, D′(h, t; xₘ), where xₘ is the surface middle point defined as

$${x}_{m} = \frac{1}{2} ( {x}_{r} + {x}_{s} )$$

and h is the offset, or h=xᵣ−xₛ. Once a seismic data set D is in the CMP domain, D′, a Fourier transform ( [symbol] ) is applied along the offset axis to obtain the seismic data set in the K-t domain, \hat{D}:

\hat{D}(k,t;xₘ)= [symbol] (D′(h,t;xₘ)). EQ 6

Seismic data that has been transformed from the X-t domain to the K-t domain is referenced as transformed seismic data (326).

Generally, training a machine-learned model requires that pairs of inputs and one or more outputs are passed to the machine-learned model. More details surrounding the training process will be provided below, however, suffice to say that during training the machine-learned model “learns” a representative model which maps the received inputs to the associated outputs. In the DL-based framework (300), each transformed seismic data set in the transformed seismic data (326) is associated with a velocity model from the velocity models A (318). A transformed seismic data set may be considered an input to the machine-learned model and the associated velocity model (from velocity models A (318)) may be considered the output. As shown in block 332, a machine-learned model (such as a deep model) is trained using pairs of inputs (shown with the directed line labelled 328) and outputs (shown with the directed line labelled 330). In summary, a machine-learned model is trained (block 332) using the transformed seismic data (326) and the velocity models A (318). The resulting machine-learned model is referred to as a trained machine-learned model (334) and is the ultimate product of the DL-based framework (300).

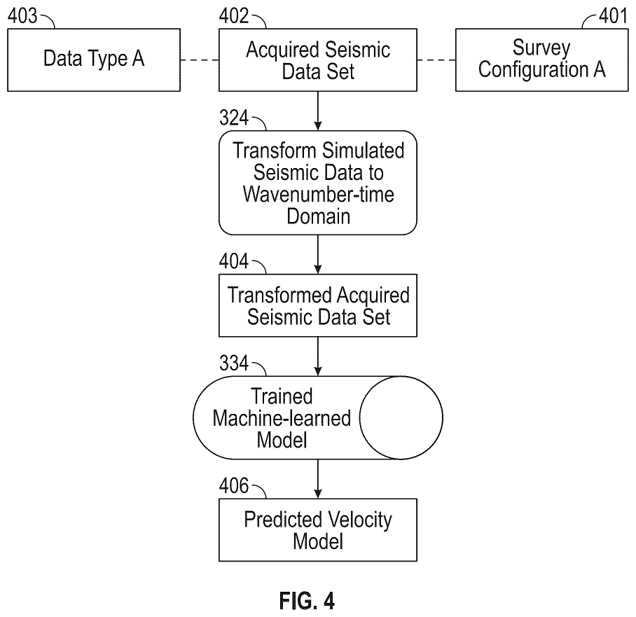

FIG. 4 depicts how the trained machine-learned model (334) is used. First, a new seismic data set is acquired; depicted in FIG. 4 as acquired seismic data set. The acquired seismic data set (402) was acquired through a seismic survey (100) conducted according to a configuration illustrated as survey configuration A (401). The acquired seismic data set (402) also corresponds to a data type (e.g., streamer data, OBN data), depicted as data type A (403). The acquired seismic data set (402) is transformed from the X-t domain to the K-t domain as described above, resulting in the transformed acquired seismic data set (404). The transformed seismic data set (404) is processed by the trained machine-learned model (334). Because the DL-based framework (300) produces a trained machine-learned model (334) which is robust to survey configuration, the survey configuration A (401) need not be the same as the survey configuration (321) used during the data simulation step (block 320) of FIG. 3. However, it is expected that the trained machine-learned model (334) was developed according to the DL-based framework of FIG. 3 using the same data type (block 310) as data type A (403). The trained machine-learned model (334), upon processing the transformed acquired seismic data set (404) produces a predicted velocity model (406). The predicted velocity model (406) is of the form of EQ. 2, wherein a velocity vector is returned for a set of spatial coordinates spanning the subterranean region of interest (102).

In accordance with one or more embodiments, the machine-learned model of the DL-based framework (300) is a long short-term memory (LSTM) network, which is a deep model. To best understand a LSTM network, it is helpful to describe the more general recurrent neural network, for which an LSTM may be considered a specific implementation.

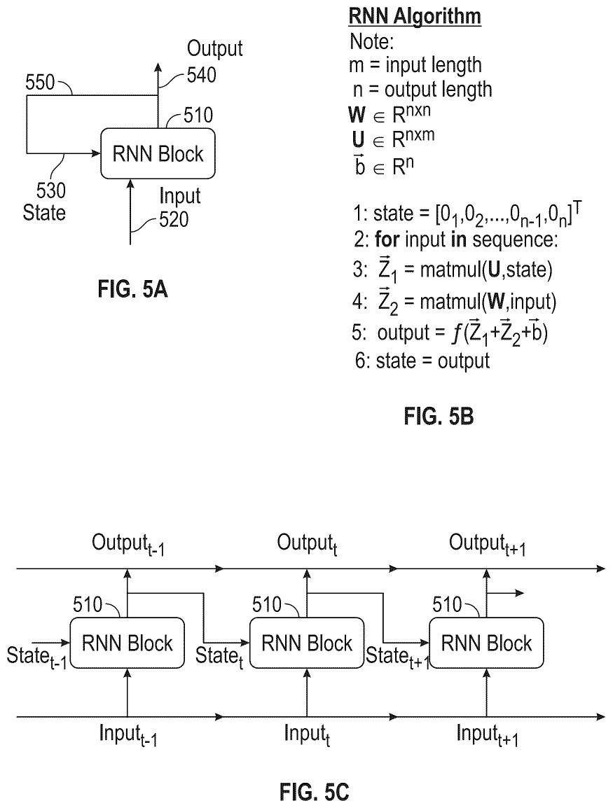

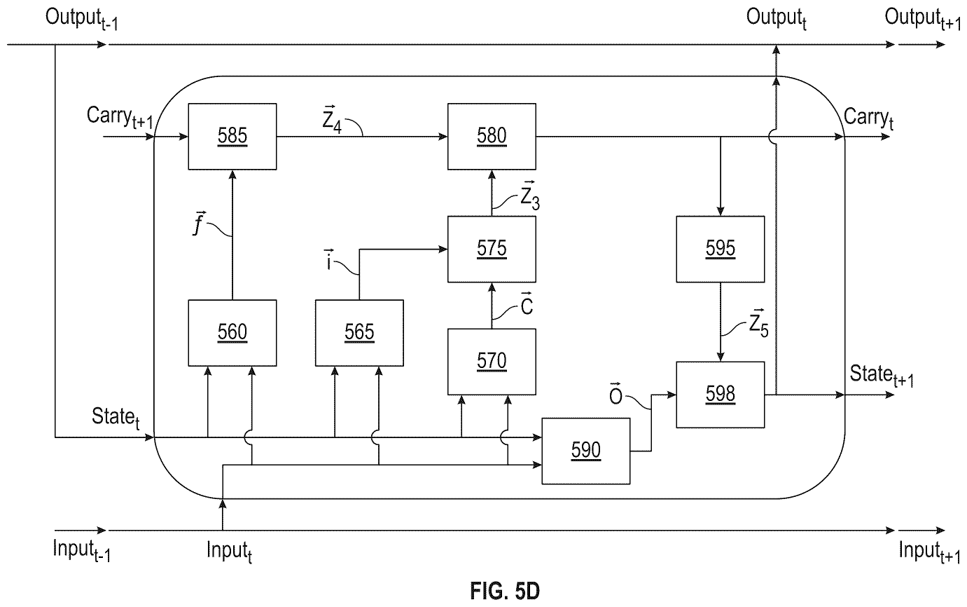

FIG. 5A depicts the general structure of a recurrent neural network (RNN). An RNN is graphically composed of an RNN Block (510) and a recurrent connection (550). The RNN Block may be thought of as a function which accepts an Input (520) and a State (530) and produces an Output (540). Without loss of generality, such a function may be written as

Output=RNN Block(Input,State). EQ 7

The RNN Block (510) generally comprises one or more matrices and one or more bias vectors. The elements of the matrices and bias vectors are commonly referred to as “weights” or “parameters” in the literature such that the matrices may be referenced as weight matrices or parameter matrices without ambiguity. However, it is noted that for problems with higher dimensional inputs (e.g. inputs with a tensor rank greater than or equal to 2), the weights of an RNN Block (510) may be contained in higher order tensors, rather than in matrices or vectors. For clarity, the present example will consider Inputs (520) as vectors such that the RNN Block (510) comprises one or more weight matrices and bias vectors, however, one with ordinary skill in the art will appreciate that this choice does not impose a limitation on the present disclosure. Typically, an RNN Block (510) has two weight matrices and a single bias vector which are distinguished with an arbitrary naming nomenclature. A commonly employed naming convention is to call one weight matrix W and the other U and to reference the bias vector as \vec{b}.

An important aspect of an RNN is that it is intended to process sequential, or ordered, data; for example, a time-series. Consequently, an Input (520) may be considered a single sequential part. As an illustration, consider a sequence composed of S parts. Each part may be considered an input, indexed by t, such that the sequence may be written as sequence=[input₁, input₂, inputₜ, . . . , input_{S-1}, input_{S}]. Each Input (520) (e.g., input₁ of a sequence) may be a scalar, vector, matrix, or higher-order tensor. For the present example, as previously discussed, each Input (520) is considered a vector with m elements. To process a sequence, an RNN receives the first ordered Input (520) of the sequence, input₁, along with a State (530), and processes them with the RNN Block (510) according to EQ. 7 to produce an Output (540). The Output (540) may be a scalar, vector, matrix, or tensor of any rank. For the present example, the Output (540) is considered a vector with n elements. The State (530) is of the same type and size as the Output (540) (e.g., a vector with n elements). For the first ordered input, the State (530) is usually initialized with all of its elements set to the value zero. For the second ordered Input (520), input₂, of the sequence, the Input (520) is processed similarly according to EQ. 7, however, the State (530) received by the RNN Block (510) is set to the value of the Output (540) determined when processing the first ordered Input (520). This process of assigning the State (530) the value of the last produced Output (540) is depicted with the recurrent connection (550) in FIG. 5A. All the Inputs (520) in a sequence are processed by the RNN Block (510) in this manner; that is, the State (530) associated with an Input (520) is the Output (540) of the RNN Block (510) produced by the previous Input (520) (with the exception of the first Input (520) in the sequence). In some implementations, each Output (540), one for each Input (510) within a sequence, is stored for later processing and use. In other implementations, only the final Output (540), or the Output (540) which is produced when the Input (520) inputs is processed by the RNN Block (510), is retained.

In greater detail, the process of the RNN Block (510), or EQ. 7, may be generally written as

Output=RNN Block(input,state)=ƒ(U·state+W·input+\vec{b}), EQ 8

where W, U, and \vec{b} are the weight matrices and bias vector of the RNN Block (510), respectively, and ƒ is an “activation function”. Some functions for ƒ may include the sigmoid function

$$f ( x ) = \frac{1}{1 + {e}^{- x}} ,$$

and rectified linear unit (ReLU) function ƒ(x)=max(0, x), however, many additional functions are commonly employed.

To further illustrate an RNN, FIGS. 5B and 5C depict alternate viewpoints of the RNN. Specifically, FIG. 5B demonstrates pseudo-code to implement an RNN. In keeping with the previous examples, both the inputs and the outputs are considered vectors of lengths m and n, respectively, however, in general, this need not be the case. With the lengths of these vectors defined, the shapes of the weight matrices, bias vector, and State (530) vector may be specified. To begin processing a sequence, the State (530) vector is initialized with values of zero as shown in line 1 of FIG. 5B. Note that in some implementations, the number of inputs contained within a sequence may not be known or may vary between sequences. One with ordinary skill in the art will recognized that an RNN may be implemented without knowing, beforehand, the length of the sequence to be processed. This is demonstrated in line 2 of FIG. 5B by indicating that each input in the sequence will be processed sequentially without specifying the number of inputs in the sequence. Once an Input (520) is received, a matrix multiplication operator is applied between the weight matrix U and the State (530) vector. The resulting product is assigned to the temporary variable \vec{z}₁. Likewise, a matrix multiplication operator is applied between the weight matrix W and the Input (510) with the result assigned to the variable \vec{z}₂. For the present example, due the Input (520) and Output (540) each being defined as vectors, the products in lines 3 and 4 of FIG. 5B may be expressed as matrix multiplications, however, in general, the dot product between the weight matrix and corresponding State (530) or Input (520) may be applied. The Output (540) is determined by summing \vec{z}₁, \vec{z}₂, and the bias vector \vec{b} and applying the activation function ƒ elementwise. The State (530) is set to the Output (540) and the whole process is repeated until each Input (520) in a sequence has been processed.

FIG. 5C depicts an “unrolled” version of the RNN of FIG. 5A. Unrolling the RNN allows one to see how the sequential inputs, indexed by t, produce sequential outputs and how the state is passed through various inputs of the sequence. It is noted that while the “unrolled” depiction shows multiple RNN Blocks (510), these blocks are the same such that they are comprised of the same weight matrices and bias vector.

As previously stated, generally, training a machine-learned model requires that pairs of inputs and one or more outputs are passed to the machine-learned model. During this process the machine-learned model “learns” a representative model which maps the received inputs to the associated outputs. In the context of an RNN, the RNN receives a sequence, wherein the sequence can be partitioned into one or more sequential parts (Inputs (520) above), and maps the sequence to an overall output, which may also be a sequence. To remove ambiguity and distinguish the overall output of an RNN from any intermediate Outputs (540) produced by the RNN Block (510), the overall output will be referred to herein as a RNN result. In other words, an RNN receives a sequence and returns a RNN result. The training procedure for a RNN comprises assigning values to the weight matrices and bias vector of the RNN Block (510). For brevity, the elements of the weight matrices and bias vector will be collectively referred to as the RNN weights. To begin training the RNN weights are assigned initial values. These values may be assigned randomly, assigned according to a prescribed distribution, assigned manually, or by some other assignment mechanism. Once the RNN weights have been initialized, the RNN may act as a function, such that it may receive a sequence and produce a RNN result. As such, at least one sequence may be propagated through the RNN to produce a RNN result. For training, a given data set will be composed of one or more sequences and desired RNN results, where the desired RNN results represent the “ground truth”, or the true RNN results that should be returned for given sequences. For clarity, the desired or true RNN results will be referred to as “targets”. When processing sequences, the RNN result produced by the RNN is compared to the associated target. The comparison of a RNN result to the target(s) is typically performed by a so-called “loss function”; although other names for this comparison function such as “error function” and “cost function” are commonly employed. Many types of loss functions are available, such as the mean squared error function, however, the general characteristic of a loss function is that the loss function provides a numerical evaluation of the similarity between the RNN result and the associated target(s). The loss function may also be constructed to impose additional constraints on the values assumed by RNN weights, for example, by adding a penalty term, which may be physics-based, or a regularization term. Generally, the goal of a training procedure is to alter the RNN weights to promote similarity between the RNN results and associated targets over a provided data set, known as the “training data set” or “training set”. Thus, the loss function is used to guide changes made to the RNN weights, typically through a process called “backpropagation” or “backpropagation through time”.

While a full review of the backpropagation process exceeds the scope of this disclosure, a brief summary is provided. Backpropagation consists of computing the gradient of the loss function over the RNN weights. The gradient indicates the direction of change in the RNN weights that results in the greatest change to the loss function. Because the gradient is local to the current RNN weights, the RNN weights are typically updated by a “step” in the direction indicated by the gradient. The step size is often referred to as the “learning rate” and need not remain fixed during the training process. Additionally, the step size and direction may be informed by previously seen RNN weights or previously computed gradients. Such methods for determining the step direction are usually referred to as “momentum” based methods.

Once the RNN weights have been updated, or altered from their initial values, through a backpropagation step, the RNN will likely produce different RNN results. Thus, the procedure of propagating at least one sequence through the RNN, comparing the RNN result with the associated target(s) with a loss function, computing the gradient of the loss function with respect to the RNN weights, and updating the RNN weights with a step guided by the gradient, is repeated until a termination criterion is reached. Common termination criteria are: reaching a fixed number of RNN weight updates, otherwise known as an iteration counter; a diminishing learning rate; noting no appreciable change in the loss function between iterations; reaching a specified performance metric as evaluated on the data or a separate hold-out data set (e.g., a “validation” or “test” data set composed of sequence and target pairs not used during training). Once the termination criterion is satisfied, and the RNN weights are no longer intended to be altered, the RNN is said to be “trained”.

A long short-term memory (LSTM) network may be considered a specific, and more complex, instance of a recurrent neural network (RNN). FIG. 5D is an unrolled depiction of an LSTM where the internal components of the LSTM are displayed as labelled abstractions. A LSTM, like an RNN, has a recurrent connection, such that the output produced by a single input in a sequence is forwarded as the state to be used with the subsequent input. However, an LSTM also possesses another “state-like” data structure commonly referred to as the “carry”. The carry, like the state and input may be a scalar, vector, matrix, or tensor of any rank depending on the context of the application. Like unto the description of the RNN, for simplicity, the carry will be considered a vector in the following discussion of the LSTM. The LSTM receives an input, state, and carry and produces an output and a new carry. The output and the new carry are passed to the LSTM as the state and carry for the subsequent input. This sequential process, indexed by t, may be described functionally as

(outputₜ,carryₜ)=LSTM Block(inputₜ,carryₜ₋₁,stateₜ)=LSTM Block(inputₜ,carryₜ₋₁,outputₜ₋₁), EQ 9

where the LSTM Block, like the RNN Block, comprises one or more weight matrices and bias vectors and the processing steps necessary to transform an input, state, and carry to an output and new carry.

LSTMs may be configured in a variety of ways, however, the processes depicted in FIG. 5D are the most common. As shown in FIG. 5D, an LSTM Block receives an input (inputₜ), a state (stateₜ), and a carry (carryₜ₋₁). Again, assuming that the inputs, carry, and outputs are all vectors, the weights of the LSTM Block may be considered to reside in eight matrices and four bias vectors. These matrices and vectors are conventionally named Wᵢ, Uᵢ, W_{ƒ}, U_{ƒ}, W_{c}, U_{c}, Wₒ, Uₒ and \vec{b}ᵢ, \vec{b}_{ƒ}, \vec{b}_{c}, \vec{b}ₒ, respectively. The processes of the LSTM Block are as follows. Block 560 represents the following operation

\vec{ƒ}=a₁(U_{ƒ}·stateₜ+W_{ƒ}·inputₜ+\vec{b}_{ƒ}),

where a₁ is an activation function applied elementwise to the result of the parenthetical expression and the resulting vector is \vec{ƒ}. Block 565 implements the following operation

\vec{i}=a₂(Uᵢ·stateₜ+Wᵢ·inputₜ+\vec{b}ᵢ),

where a₂ is an activation function which may be the same or different to a₁ and is applied elementwise to the result of the parenthetical expression. The resulting vector is \vec{i}. Block 570 implements the following operation

\vec{c}=a₃(U_{c}·stateₜ+W_{c}·inputₜ+\vec{b}_{c}),

where a₃ is an activation function which may be the same or different to either a₁ or a₂ and is applied elementwise to the result of the parenthetical expression. The resulting vector is \vec{c}. In block 575, vectors \vec{i} and \vec{c} are multiplied according to

\vec{z}₃=\vec{i}⊙\vec{c},

where ⊙ indicates the Hadamard product (i.e., elementwise multiplication). Likewise, in block 585 the carry vector from the previous sequential input (carryₜ₋₁) vector and the vector \vec{ƒ} are multiplied according to

\vec{z}₄=carryₜ₋₁⊙\vec{ƒ}.

The results of the operations of blocks 575 and 585 (\vec{z}₃ and \vec{z}₄, respectively) are added together in block 580 to form the new carry (carryₜ);

carryₜ=\vec{z}₃+\vec{z}₄.

In block 590, the current input and state vectors are processed according to

\vec{o}=a₄(Uₒ·stateₜ+Wₒ·inputₜ+\vec{b}ₒ),

where a₄ is an activation function which may be unique or identical to any other used activation function and is applied elementwise to the result of the parenthetical expression. The result is the vector \vec{o}. In block 595, the new carry (carryₜ) is passed through an activation function a₅. The activation a₅ is usually the hyperbolic tangent function but may be any known activation function. The operations of block 595 may be represented as

\vec{z}₅=a₅(carryₜ).

Finally, the output of the LSTM Block (outputₜ) is determined in block 598 by taking the Hadamard product of \vec{z}₅ and \vec{o}, shown as

outputₜ=\vec{z}₅⊙\vec{o}.

The output of the LSTM Block is used as the state vector for the subsequent input. Again, as in the case of the RNN, the outputs of the LSTM Block applied to a sequence of inputs may be stored and further processed or, in some implementations, only the final output is retained. While the processes of the LSTM Block described above used vector inputs and outputs, it is emphasized that an LSTM network may be applied to sequences of any dimensionality. In these circumstances the rank and size of the weight tensors will change accordingly. One with ordinary skill in the art will recognized that there are many alterations and variations that can be made to the general LSTM structure described herein, such that the description provided does not impose a limitation on the present disclosure.

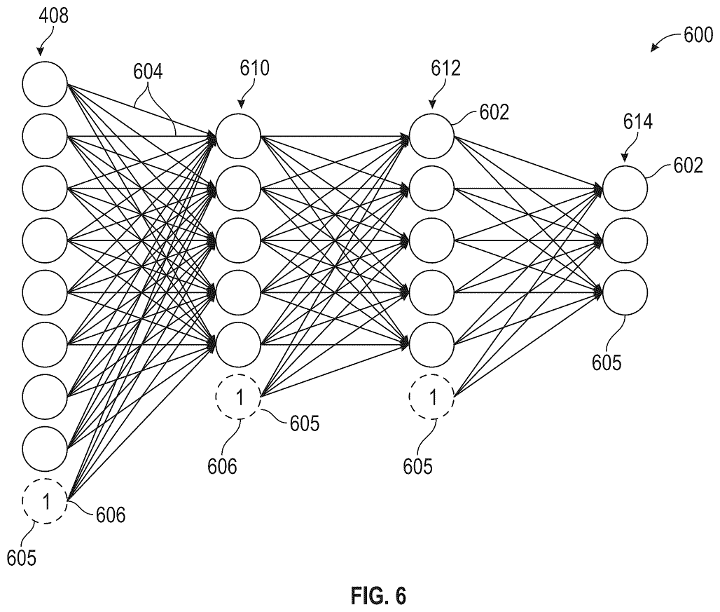

In accordance with one or more embodiments, the RNN result, or the final result of an LSTM, may be further processed with a neural network. A diagram of a neural network is shown in FIG. 6. At a high level, a neural network (600) may be graphically depicted as being composed of nodes (602), where here any circle represents a node, and edges (604), shown here as directed lines. The nodes (602) may be grouped to form layers (605). FIG. 6 displays four layers (608, 610, 612, 614) of nodes (602) where the nodes (602) are grouped into columns, however, the grouping need not be as shown in FIG. 6. The edges (604) connect the nodes (602). Edges (604) may connect, or not connect, to any node(s) (602) regardless of which layer (605) the node(s) (602) is in. That is, the nodes (602) may be sparsely and residually connected. A neural network (600) will have at least two layers (605), where the first layer (608) is considered the “input layer” and the last layer (614) is the “output layer”. Any intermediate layer (610, 612) is usually described as a “hidden layer”. A neural network (600) may have zero or more hidden layers (610, 612) and a neural network (600) with at least one hidden layer (610, 612) may be described a “deep” neural network or a “deep learning method”. In general, a neural network (600) may have more than one node (602) in the output layer (614). In this case the neural network (600) may be referred to as a “multi-target” or “multi-output” network.

Nodes (602) and edges (604) carry additional associations. Namely, every edge is associated with a numerical value. The edge numerical values, or even the edges (604) themselves, are often referred to as “weights” or “parameters” and are analogous to the weights of a RNN. While training a neural network (600), numerical values are assigned to each edge (604). Additionally, every node (602) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) ,$$

where i is an index that spans the set of “incoming” nodes (602) and edges (604) and ƒ is a user-defined function. Incoming nodes (602) are those that, when viewed as a graph (as in FIG. 6), have directed arrows that point to the node (602) where the numerical value is being computed. Some functions for ƒ may include the linear function ƒ(x)=x, sigmoid function

$$f ( x ) = \frac{1}{1 + {e}^{- x}} ,$$

and rectified linear unit (ReLU) function ƒ(x)=max(0, x), however, many additional functions are commonly employed. Every node (602) in a neural network (600) may have a different associated activation function. Often, as a shorthand, activation functions are described by the function ƒ by which it is composed. That is, an activation function composed of a linear function ƒ may simply be referred to as a linear activation function without undue ambiguity.

When the neural network (600) receives a network input (e.g., the final output of an LSTM), the network input is propagated through the network according to the activation functions and incoming node (602) values and edge (604) values to compute a value for each node (602). That is, the numerical value for each node (602) may change for each received input. Occasionally, nodes (602) are assigned fixed numerical values, such as the value of 1, that are not affected by the input or altered according to edge (604) values and activation functions. Fixed nodes (602) are often referred to as “biases” or “bias nodes” (606), displayed in FIG. 6 with a dashed circle.

In some implementations, the neural network (600) may contain specialized layers (605), such as a normalization layer, or additional connection procedures, like concatenation. One skilled in the art will appreciate that these alterations do not exceed the scope of this disclosure.

As noted, the training procedure for the neural network (600) comprises assigning values to the edges (604). The training procedure for the neural network (600) is substantially similar to the training process for an RNN (or LSTM), where initial values are assigned the edges (604) and these values are updated via backpropagation according to a loss function. When a neural network (600) receives as a network input the RNN result (or final output of an LSTM), the neural network (600) is often considered part of the RNN (or LSTM). In other words, a RNN (or LSTM) may include a neural network (600). It is noted that when a RNN (or LSTM) includes a neural network (600), the weights and edge (604) values are learned together through a joint training process. A machine-learned model may be composed of both an RNN (e.g., a LSTM) and a neural network (600) and this machine-learned model may be referenced simply as a RNN (or LSTM) with implicit inclusion of the neural network (600).

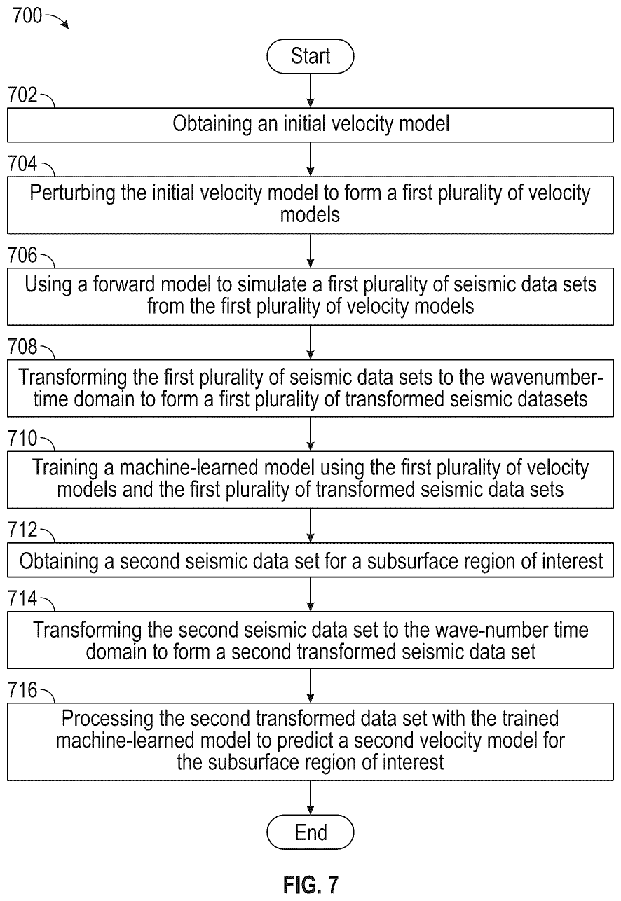

In accordance with one or more embodiments, FIG. 7 depicts a flowchart (700) outlining the steps of the DL-based framework (300) and using the resulting trained machine-learned model (334) to determine a velocity model from seismic data. As illustrated in block 702 of FIG. 7, first, an initial velocity model is obtained. This model may be generated from a benchmark model (312) using seismic data from a seismic data database (302). As shown in block 704, the initial velocity model is perturbed to form a first plurality of velocity models. The procedure for perturbing the initial velocity model may be controlled by a variety of perturbation parameters (316). The perturbation parameters (316) may include the number of subterranean layers, the thicknesses of the layers, and the distribution of velocities in each layer. For example, velocity value in each layer may be randomly assigned within a pre-defined value range based on the initial velocity model and which makes geological sense while incorporating prior knowledge (314). In block 706, a forward model is used to simulate a first plurality of seismic data sets from the first plurality of velocity models. The forward modeling process simulates the propagation of a seismic wave from one or more seismic sources (106) through a subterranean region of interest (102) to one or more simulated seismic receivers (120). The forward modelling process accepts the first plurality of velocity models and returns a first plurality of seismic data sets. Each seismic data set represents the recorded data, or the simulated recorded data at each simulated seismic receiver (120). In other words, each simulated seismic data set is a collection of traces, where each trace is a record in time of the amplitude of simulated ground motion. Each data set in the first plurality of seismic data sets resides in the X-t domain. As shown in block 708, the first plurality of seismic data sets is transformed to the wavenumber-time domain (K-t domain) forming a first plurality of transformed seismic data sets. The transformation may include first sorting each seismic data set according to its common middle point (CMP) domain and applying a Fourier transform.

A machine-learned model is trained using the first plurality of velocity models and the first plurality of transformed seismic data sets, as shown in block 710. Training the machine-learned model may encompass splitting the seismic data set and velocity model pairs into training, validation, and test sets. In accordance with one or more embodiments, the machine-learned model is trained using the training set and the hyperparameters of the machine-learned model are tuned by evaluating the machine-learned model on the validation set. Further, the generalization performance of the machine-learned model may be estimated by evaluating the model on the test set. In some implementations, the validation set and test set are the same. Further, one with ordinary skill in the art will appreciate that other common training procedures and techniques, such as cross-validation, may be employed without exceeding the scope of the present disclosure. In accordance with one or more embodiments, the seismic data set and velocity model pairs are split into training, validation, and test sets such that there is a balanced representation of velocity models between each respective set. Sets of velocity models may be compared for similarity through statistical descriptors such as the distribution (mean, standard deviation) of the velocity models contained within a set.

Keeping with FIG. 7, the result of block 710 is a trained machine-learned model capable of accepting a transformed seismic data set and producing a velocity model. As depicted in block 712, a second seismic data set for a subsurface region of interest is obtained. The second seismic data set may originate from a subsurface region of interest different from any data contained in the seismic data database (302). Additionally, the second seismic data set may be acquired using a seismic survey (100) with a survey configuration not previously seen or different from the survey configuration (321) depicted in FIG. 3. In block 714, the second seismic data set is transformed to the wavenumber-time domain (K-t domain) to form a second transformed seismic data set. As depicted in block 716, the second transformed seismic data set is processed with the trained machine-learned model, produced in block 710, to predict a second velocity model for the subsurface region of interest corresponding to the second seismic data set.

While the various blocks in FIG. 7 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

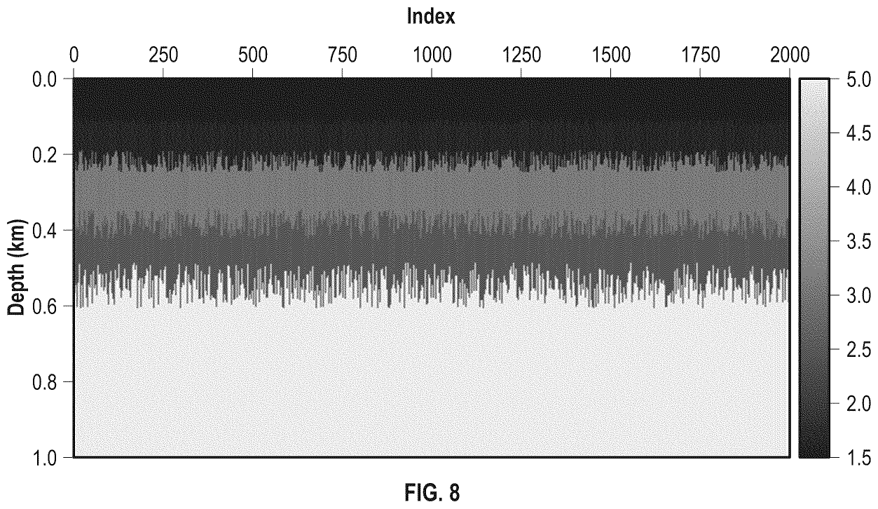

FIGS. 8-13 demonstrate a characterization test of the DL-based framework (300) to produce a machine-learned model to determine a velocity model from seismic data and further show the machine-learned model's robustness to survey configurations. In the following examples, for clarity, the subsurface region of interest is modelled in a single dimension. Mathematically, for a one-dimensional model, a velocity model may be represented with a reduced version of EQ. 2 as

v=m(d)

or v=m(t), EQ10

where v is the scalar velocity (isotropic) which may be related to either a depth d in the subsurface region of interest or a time t (e.g., converted from d via depth-to-time conversion). Upon receiving an initial velocity model, a first plurality of velocity models is generated through perturbations. FIG. 8 depicts 2000 velocity models (the first plurality of velocity models) based on the initial velocity model. In other words, FIG. 8 is a graphical display of models m₁, m₂, . . . , m₁₉₉₉, m₂₀₀₀ after the manner of EQ. 10 where each model describes a velocity according to a depth. In some embodiments, the initial velocity model and the first plurality of velocity models may relate velocity to time instead of depth.

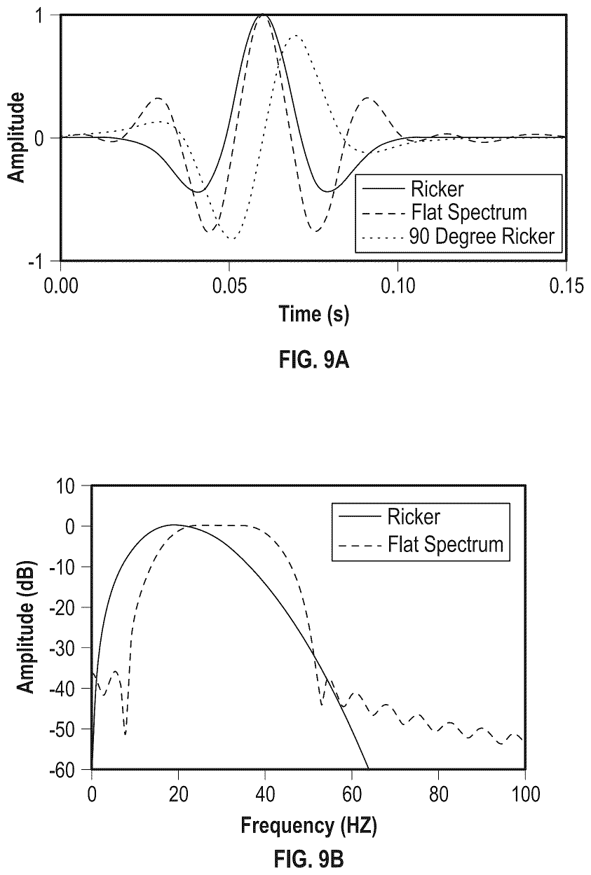

Using the forward modelling process described above, the first plurality of velocity models (FIG. 8) is converted to a first plurality of seismic data sets. The forward modelling process requires a survey configuration (321). To test the invariance of the DL-based framework (300) to survey configuration (321), for the characterization test, four survey configurations (321) were used. These configurations define the source wavelet by specifying its form, frequency band, and phase, as well as the spacing of regularly spaced simulated seismic receivers (120). The specifics of these configurations are provided in Table I. For clarity, these configurations are labelled as configuration (a), configuration (b), configuration (c), and configuration (d). Further, FIGS. 9A and 9B depict the normalized wavelet amplitude with respect to time and the frequency spectrum of the wavelets, respectively.

TABLE I
Survey Configurations.

| | Configuration: | | | | |
|---|---|---|---|---|---|
| | (a) | (b) | (c) | | (d) |
| Source | 20 Hz | 20 Hz | 20 Hz | | 15-50 Hz |
| Wavelet | Ricker | Ricker | Ricker | | flat |
| Phase | 0 | 0 | 90 | degree | 0 |
| Receiver | 25 m | 18.75 m | 25 | m | 25 m |
| Spacing | | | | | |

Given that four survey configurations are used in the present characterization test, four pluralities of seismic data sets are created through the forward modelling process; namely, a first, second, third, and fourth plurality of seismic data sets each corresponding to the first plurality of velocity models (2000 perturbed models) and the four survey configurations, respectively. It is emphasized that in practice only a single survey configuration (321) is required and that the use of four configurations herein is to demonstrate the robustness of the DL-based framework (300).

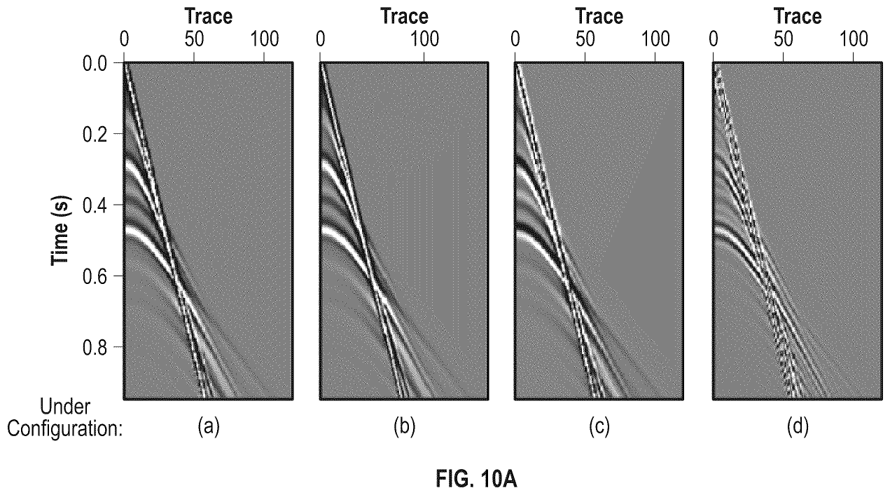

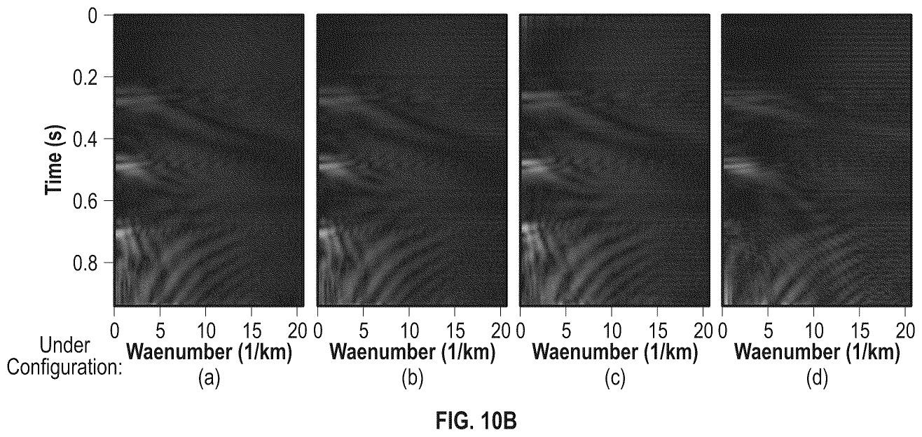

Turning to FIG. 10A, FIG. 10A depicts examples of a single simulated seismic data set produced with the forward modelling process under the four survey configurations identified in Table I. Note that the simulated seismic data sets in FIG. 10A are all produced from the same velocity model and differ only in the survey configuration (321) of the forward modelling process. The first, second, third, and fourth pluralities of seismic data sets are transformed to the K-t domain forming a first, second, third, and fourth plurality of transformed seismic data sets. FIG. 10B depicts the seismic data sets of FIG. 10A after transformation to the K-t domain.

For the present example, the first, second, third, and forth pluralities of seismic data sets are used to train four machine-learned models; one per plurality of seismic data sets. For example, the first plurality of seismic data sets is used with the first plurality of velocity models to train a first machine-learned model. Likewise, the second plurality of seismic data sets are used with the first plurality of velocity models to train a second machine-learned model. These models, because they accept and act on untransformed seismic data sets, and therefore do not follow the DL-based framework (300) described herein, may be considered benchmark models (312). Further, for the purposes of the characterization test, the performance may be used as a useful baseline for models developed under the DL-based framework (300).

In a similar fashion, four additional machine-learned models are trained using the first, second, third, and fourth pluralities of transformed seismic data sets. For example, the first plurality of transformed seismic data sets is used with the first plurality of velocity models to train a fifth machine-learned model. In total, eight machine-learned models are trained, one for each plurality of seismic data sets and each plurality of transformed seismic data sets. It is emphasized that in practice eight machine-learned models would not be trained and that these models are only developed in the present example to compare the models and subsequently characterize the performance and robustness models developed under the DL-based framework (300).

For training the eight machine-learned models, the loss function employed is

L=∥y−ŷ∥ₚ+α∥∇ŷ∥ₚ+β∥ŷ∥ₚ, EQ 11

where y is the true (or target) velocity model, ŷ is the predicted velocity model determined by a machine-learned model, and the ∥·∥ₚ operator indicates a mathematical norm of order p, where p is a hyperparameter. The term ∥y−ŷ∥ₚ quantifies the difference, or error, between the predicted velocity model and the true velocity model. The expression ∥∇ŷ∥ₚ quantifies the gradient of the predicted velocity model. Predicted velocity models with abrupt changes in velocity through the depth of the subsurface region of interest will result in a relatively large value for ∥∇ŷ∥ₚ. Likewise, ∥ŷ∥ₚ quantifies the overall magnitude of the velocities throughout the depth of the subsurface region of interest as predicted by the machine-learned model. Because, conventionally, loss functions are sought to be minimized, the latter two terms of EQ. 11 act as regularization terms where predicted velocity models with large gradients or large velocity values are penalized. α and β are hyperparameters and their values indicate the regularization strength of their associated terms. For the present example, the following values were used for the hyperparameters: p=1, α=1e−4 and β=1e−4.

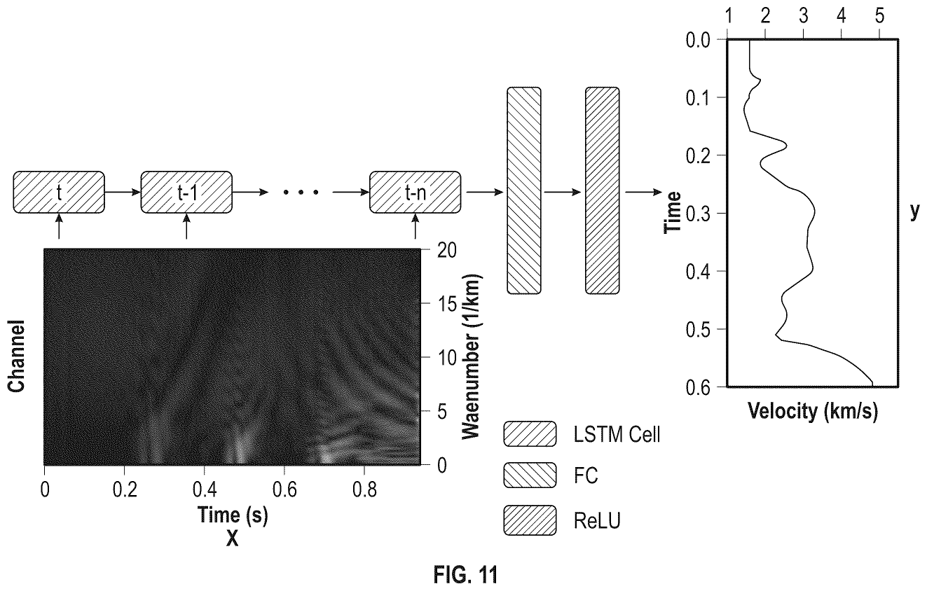

As shown in FIG. 11, the machine-learned model is a LSTM network. The LSTM network depicted in FIG. 11 accepts, as a sequence, a transformed seismic data set (i.e, data in the K-t domain). An input to the LSTM, or a sequential part of the sequence, is a vector of wavenumbers at a given time. The LSTM processes the input and produces an intermediate output, labelled in FIG. 11 as a timestep from t₀ to tₙ, where n is the number of inputs in the sequence. The intermediate outputs are collected, in a sequence, to form the overall output of the LSTM. In the present example, the overall output of the LSTM is passed to a fully connected (FC) layer with a ReLU activation function. The FC layer with ReLU activation is analogous to a single-layered neural network (600) with a ReLU activation function. Thus, in accordance with one or more embodiments, the FC layer and activation function may be considered part of the LSTM network. The output of the LSTM network (or machine-learned model) is a velocity model, as shown in FIG. 11. The machine-learned model may be configured such that the produced velocity model relates velocities to either depth or the time (See EQ. 10). In the present example, the velocity model output by the LSTM network is represented in the time domain. However, in other embodiments, the velocity model may be converted between time and depth representations. Further, in some embodiments, the machine-learned model may be trained, or otherwise configured, to implicitly perform a conversion between time and depth representations. While the LSTM network depicted in FIG. 11 acts on a transformed seismic data set, the first, second, third, and fourth machine-learned models are configured to act on seismic data sets in the X-t domain.

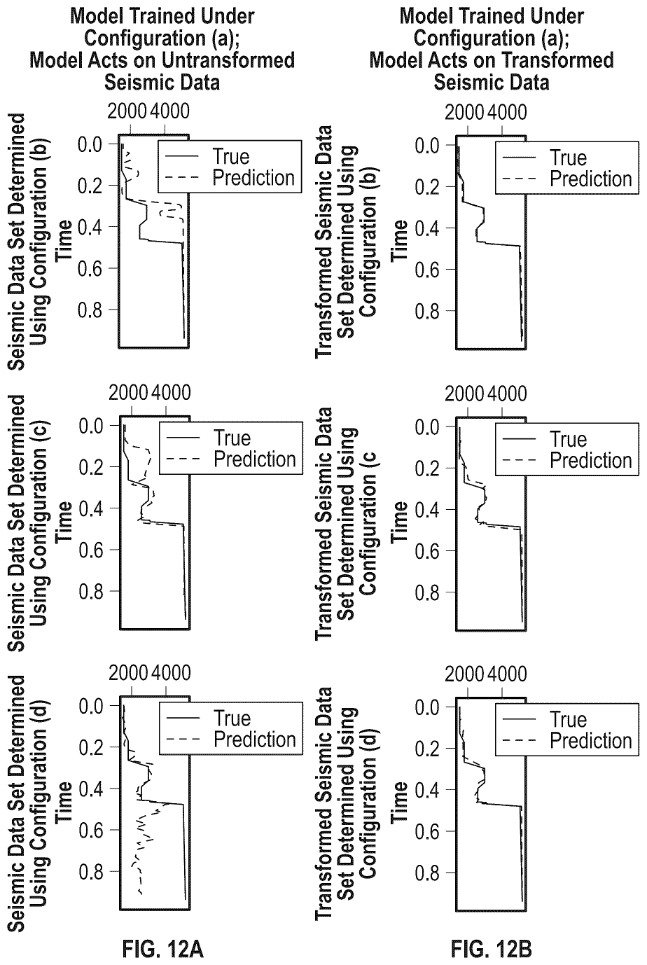

FIG. 12A depicts comparisons of a predicted velocity model, predicted using a trained machine-learned model, to the actual velocity model. Specifically, the machine-learned model of FIG. 12A was trained using the first plurality of seismic data sets (untransformed), which is the plurality of seismic data sets which were simulated using the forward modelling process while using configuration (a). In other words, the trained machine-learned model of FIG. 12A is the first machine-learned model of the eight machine-learned models of the characterization test. A single velocity model from the first plurality of velocity models was used with the forward modelling process using configurations (b), (c), and (d) to create three seismic data sets. These seismic data sets were retained in the X-t domain and processed with the stated trained machine-learned model (the first machine-learned model). As such, FIG. 12A depicts predicted velocity models where the prediction was determined from a seismic data set using a machine-learned model which was trained using a different survey configuration than that of the received seismic data set. As can be seen in FIG. 12A, the predicted velocity models differ wildly from the true velocity model.

FIG. 12B likewise depicts comparisons of a predicted velocity model, predicted using a trained machine-learned model, to the actual velocity model. Specifically, the machine-learned model of FIG. 12B was trained using the first plurality of transformed seismic data sets, which is the plurality of seismic data sets which were simulated using the forward modelling process while using configuration (a). In other words, the trained machine-learned model of FIG. 12B is the fifth machine-learned model. A single velocity model from the first plurality of velocity models was used with the forward modelling process using configurations (b), (c), and (d) to create three seismic data sets. These seismic data sets were subsequently transformed to the K-t domain and processed with the stated trained machine-learned model (the fifth machine-learned model). As such, FIG. 12B depicts predicted velocity profiles where the prediction was determined from a transformed seismic data set using a machine-learned model which was trained using a different survey configuration than that of the received transformed seismic data set. As can be seen in FIG. 12B, the predicted velocity model closely aligns with the true velocity model despite the differences in survey configurations surrounding the simulated seismic data acquisition.

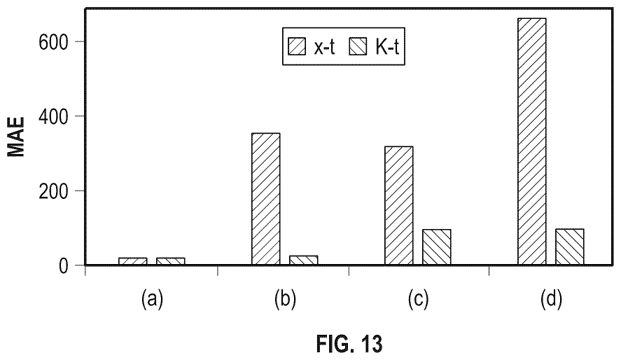

The plots FIGS. 12A and 12B initially demonstrate that a machine-learned model trained using the DL-based framework (300) described herein, using transformed seismic data, is invariant to survey configuration. However, the plots of FIGS. 12A and 12B only depict the results of a single velocity model tested under a single combination of configurations (e.g., a machine-learned model trained using configuration (a) and tested on configurations (b), (c), and (d)). To better quantify the robustness of the machine-learned models produced using the DL-based framework (300), the absolute error, or the absolute difference between a predicted velocity model and true velocity model, can be aggregated for each velocity model in the first plurality of velocity models. The results of such an aggregation are depicted in FIG. 13 as the mean absolute error (MAE). In other words, the first and fifth machine-learned models, or those models trained with seismic data sets simulated under configuration (a), are applied to first through fourth pluralities of seismic data sets (seismic data sets simulated using configurations (a), (b), (c), and (d), respectively). As can be seen in FIG. 13, on average, the machine-learned model produced under the DL-based framework (300) (the fifth machine-learned model), which uses transformed seismic data sets, demonstrates invariance to survey configuration (300). Also seen in FIG. 13 is that the machine-learned model trained with untransformed seismic data sets (the first machine-learned model) cannot generalize to accurately predict velocity models for seismic data acquired using a different survey configuration (321).

Additional MAE plots may be constructed for other combinations of training-test configurations. For example, training a machine-learned model on seismic data sets simulated under configuration (b) and testing the model's accuracy on seismic data sets generated with the remaining configurations. For brevity, these plots are not shown, however, the results are similar to that of FIG. 13.

As stated, the examples of FIGS. 8-13 uses one-dimensional velocity models. However, one with ordinary skill in the art will recognized that the DL-based framework (300) and the associated method and processes described herein are not limited to one-dimensional cases. That is, the DL-based framework (300) and the produced machine-learned model may operate on 2D or 3D seismic data to predict 2D or 3D velocity models.

Embodiments of the present disclosure may provide at least one of the following advantages. In accordance with one or more embodiments, the DL-based framework (300) described herein produces a machine-learned model that may determine a velocity model from seismic data. The machine-learned model is robust and may generalize to seismic data acquired using survey configurations that differ from the survey configurations (321) used to simulate the training data. As such, a single machine-learned model may generalize to many seismic data sets (of the same data type (streamer data, etc.)) without needing to re-train, or otherwise tailor, the machine-learned model to a specific survey configuration (321). This represents a significant reduction in cost, in terms of both time and computational resources, to produce one or more accurate machine-learned models.

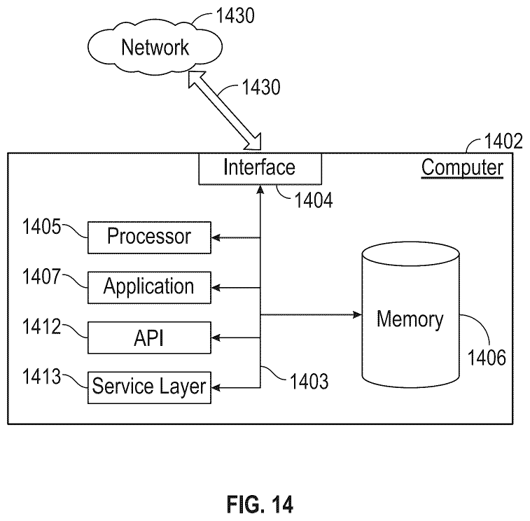

FIG. 14 further depicts a block diagram of a computer system (1402) used to provide computational functionalities associated with described algorithms, methods, functions, processes, flows, and procedures as described in this disclosure, according to one or more embodiments. The illustrated computer (1402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1402) may include a computer that includes an input device, such as a keypad, keyboard, touch screen, or other device that can accept user information, and an output device that conveys information associated with the operation of the computer (1402), including digital data, visual, or audio information (or a combination of information), or a GUI.

The computer (1402) can serve in a role as a client, network component, a server, a database or other persistency, or any other component (or a combination of roles) of a computer system for performing the subject matter described in the instant disclosure. In some implementations, one or more components of the computer (1402) may be configured to operate within environments, including cloud-computing-based, local, global, or other environment (or a combination of environments).

At a high level, the computer (1402) is an electronic computing device operable to receive, transmit, process, store, or manage data and information associated with the described subject matter. According to some implementations, the computer (1402) may also include or be communicably coupled with an application server, e-mail server, web server, caching server, streaming data server, business intelligence (BI) server, or other server (or a combination of servers).

The computer (1402) can receive requests over network (1430) from a client application (for example, executing on another computer (1402) and responding to the received requests by processing the said requests in an appropriate software application. In addition, requests may also be sent to the computer (1402) from internal users (for example, from a command console or by other appropriate access method), external or third-parties, other automated applications, as well as any other appropriate entities, individuals, systems, or computers.

Each of the components of the computer (1402) can communicate using a system bus (1403). In some implementations, any or all of the components of the computer (1402), both hardware or software (or a combination of hardware and software), may interface with each other or the interface (1404) (or a combination of both) over the system bus (1403) using an application programming interface (API) (1412) or a service layer (1413) (or a combination of the API (1412) and service layer (1413). The API (1412) may include specifications for routines, data structures, and object classes. The API (1412) may be either computer-language independent or dependent and refer to a complete interface, a single function, or even a set of APIs. The service layer (1413) provides software services to the computer (1402) or other components (whether or not illustrated) that are communicably coupled to the computer (1402). The functionality of the computer (1402) may be accessible for all service consumers using this service layer. Software services, such as those provided by the service layer (1413), provide reusable, defined business functionalities through a defined interface. For example, the interface may be software written in JAVA, C++, or other suitable language providing data in extensible markup language (XML) format or another suitable format. While illustrated as an integrated component of the computer (1402), alternative implementations may illustrate the API (1412) or the service layer (1413) as stand-alone components in relation to other components of the computer (1402) or other components (whether or not illustrated) that are communicably coupled to the computer (1402). Moreover, any or all parts of the API (1412) or the service layer (1413) may be implemented as child or sub-modules of another software module, enterprise application, or hardware module without departing from the scope of this disclosure.

The computer (1402) includes an interface (1404). Although illustrated as a single interface (1404) in FIG. 14, two or more interfaces (1404) may be used according to particular needs, desires, or particular implementations of the computer (1402). The interface (1404) is used by the computer (1402) for communicating with other systems in a distributed environment that are connected to the network (1430). Generally, the interface (1404) includes logic encoded in software or hardware (or a combination of software and hardware) and operable to communicate with the network (1430). More specifically, the interface (1404) may include software supporting one or more communication protocols associated with communications such that the network (1430) or interface's hardware is operable to communicate physical signals within and outside of the illustrated computer (1402).

The computer (1402) includes at least one computer processor (1405). Although illustrated as a single computer processor (1405) in FIG. 14, two or more processors may be used according to particular needs, desires, or particular implementations of the computer (1402). Generally, the computer processor (1405) executes instructions and manipulates data to perform the operations of the computer (1402) and any algorithms, methods, functions, processes, flows, and procedures as described in the instant disclosure.

The computer (1402) also includes a memory (1406) that holds data for the computer (1402) or other components (or a combination of both) that can be connected to the network (1430). The memory may be a non-transitory computer readable medium. For example, memory (1406) can be a database storing data consistent with this disclosure. Although illustrated as a single memory (1406) in FIG. 14, two or more memories may be used according to particular needs, desires, or particular implementations of the computer (1402) and the described functionality. While memory (1406) is illustrated as an integral component of the computer (1402), in alternative implementations, memory (1406) can be external to the computer (1402).

The application (1407) is an algorithmic software engine providing functionality according to particular needs, desires, or particular implementations of the computer (1402), particularly with respect to functionality described in this disclosure. For example, application (1407) can serve as one or more components, modules, applications, etc. Further, although illustrated as a single application (1407), the application (1407) may be implemented as multiple applications (1407) on the computer (1402). In addition, although illustrated as integral to the computer (1402), in alternative implementations, the application (1407) can be external to the computer (1402).

There may be any number of computers (1402) associated with, or external to, a computer system containing computer (1402), wherein each computer (1402) communicates over network (1430). Further, the term “client,” “user,” and other appropriate terminology may be used interchangeably as appropriate without departing from the scope of this disclosure. Moreover, this disclosure contemplates that many users may use one computer (1402), or that one user may use multiple computers (1402).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A method, comprising:
obtaining an initial velocity model;
perturbing the initial velocity model to form a first plurality of velocity models;
using a forward model to simulate a first plurality of seismic data sets from the first plurality of velocity models;
transforming the first plurality of seismic data sets to a wavenumber-time domain to form a first plurality of transformed seismic data sets;
training a machine-learned model using the first plurality of velocity models and the first plurality of transformed seismic data sets, wherein the machine-learned model is configured to accept transformed seismic data sets;
obtaining a second seismic data set for a subsurface region of interest, wherein the second seismic data set is acquired according to a second survey configuration;
transforming the second seismic data set to the wavenumber-time domain to form a second transformed seismic data set; and
processing the second transformed data set with the trained machine-learned model to predict a second velocity model for the subsurface region of interest.

2. The method of claim 1,
wherein transforming the first plurality of seismic data sets and transforming the second seismic data set further comprises:
sorting the data to a common middle point; and
applying a Fourier transform to the sorted data.

3. The method of claim 1,
wherein the machine-learned model comprises a long-short-term-memory network.

4. The method of claim 1, further comprising:
constructing a subsurface model for the subsurface region of interest based, at least in part, on the second velocity model, wherein the subsurface model informs oil and gas field planning and lifecycle management decisions.

5. The method of claim 1, further comprising:
obtaining a seismic data database of various data types;
selecting a third seismic data set from the seismic data database according to a data type; and
processing the third seismic data set with a benchmark model to determine the initial velocity model.

6. The method of claim 1,
wherein the forward model is configured according to a first survey configuration which is non-identical to the second survey configuration.

7. The method of claim 1,
wherein the initial velocity model is perturbed according to a prior knowledge and a plurality of perturbation parameters, wherein the prior knowledge comprises:
petrophysical information about the subsurface region of interest.

8. A non-transitory computer readable medium storing instructions executable by a compute processor, the instructions comprising functionality for:
obtaining an initial velocity model;
perturbing the initial velocity model to form a first plurality of velocity models;
using a forward model to simulate a first plurality of seismic data sets from the first plurality of velocity models;
transforming the first plurality of seismic data sets to a wavenumber-time domain to form a first plurality of transformed seismic data sets;
training a machine-learned model using the first plurality of velocity models and the first plurality of transformed seismic data sets, wherein the machine-learned model is configured to accept transformed seismic data;
obtaining a second seismic data set for a subsurface region of interest, wherein the second seismic data set is acquired according to a second survey configuration;
transforming the second seismic data set to the wavenumber-time domain to form a second transformed seismic data set; and
processing the second transformed data set with the trained machine-learned model to predict a second velocity model for the subsurface region of interest.

9. The non-transitory computer readable medium of claim 8,
wherein transforming the first plurality of seismic data sets and transforming the second seismic data set further comprises:
sorting the data to a common middle point; and
applying a Fourier transform to the sorted data.

10. The non-transitory computer readable medium of claim 8,
wherein the machine-learned model comprises a long-short-term-memory network.

11. The non-transitory computer readable medium of claim 8, further comprising instructions for:
constructing a subsurface model for the subsurface region of interest based, at least in part, on the second velocity model, wherein the subsurface model informs oil and gas field planning and lifecycle management decisions.

12. The non-transitory computer readable medium of claim 8, further comprising instructions for:
obtaining a seismic data database of various data types;
selecting a third seismic data set from the seismic data database according to a data type; and
processing the third seismic data set with a benchmark model to determine the initial velocity model.

13. The non-transitory computer readable medium of claim 8,
wherein the forward model is configured according to a first survey configuration which is non-identical to the second survey configuration.

14. The non-transitory computer readable medium of claim 8,
wherein the initial velocity model is perturbed according to a prior knowledge and a plurality of perturbation parameters, wherein the prior knowledge comprises:
petrophysical information about the subsurface region of interest.

15. A system, comprising:
an initial velocity model;
a forward modelling procedure;
a machine-learned model;
a second seismic data set for a subsurface region of interest, wherein the second seismic data set is acquired according to a second survey configuration; and
a computer comprising:
one or more computer processors, and
a non-transitory computer readable medium storing instructions executable by a computer processor, the instructions comprising functionality for:
perturbing the initial velocity model to form a first plurality of velocity models;
using the forward modelling procedure to simulate a first plurality of seismic data sets from the first plurality of velocity models;
transforming the first plurality of seismic data sets to a wavenumber-time domain to form a first plurality of transformed seismic data sets;
training the machine-learned model using the first plurality of velocity models and the first plurality of transformed seismic data sets, wherein the machine-learned model is configured to accept transformed seismic data;
transforming the second seismic data set to the wavenumber-time domain to form a second transformed seismic data set; and
processing the second transformed data set with the trained machine-learned model to predict a second velocity model for the subsurface region of interest.

16. The system of claim 15,
wherein transforming the first plurality of seismic data sets and transforming the second seismic data set further comprises:
sorting the data to a common middle point; and
applying a Fourier transform to the sorted data.

17. The system of claim 15,
wherein the machine-learned model comprises a long-short-term-memory network.

18. The system of claim 15, the instructions further comprising functionality for:
constructing a subsurface model for the subsurface region of interest based, at least in part, on the second velocity model, wherein the subsurface model informs oil and gas field planning and lifecycle management decisions.

19. The system of claim 15, further comprising:
a seismic data database of various data types; and
a third seismic data set selected from the seismic data database according to a data type;
wherein, the initial velocity model is determined by processing the third seismic data set with a benchmark model.

20. The system of claim 15,
wherein the initial velocity model is perturbed according to a prior knowledge and a plurality of perturbation parameters, wherein the prior knowledge comprises:
petrophysical information about the subsurface region of interest.
